(19) United States
(12) Patent Application Publication
(10) Pub. No.: US 2010/0245897 A1
(43) Pub. Date: Sep. 30, 2010

(54) ELECTRONIC APPARATUS AND IMAGE FORMING SYSTEM

(75) Inventors: Hiromoto ANDO, Kanagawa (JP); Kiyoko Shimadate, Kanagawa (JP); Hiroshi Shida, Kanagawa (JP); Toshiaki Kuwahara, Kanagawa (JP); Takashi Hirata, Kanagawa (JP); Takashi Nakamura, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJI XEROX CO., LTD., Tokyo (JP)

(21) Appl. No.: 12/568,011

(22) Filed: Sep. 28, 2009

(30) Foreign Application Priority Data
Mar. 25, 2009 (JP) 2009-074704

(51) Int. Cl. G06F 3/12; G06F 17/30

(52) U.S. Cl. 358/1.15; 726/5

(57) ABSTRACT

An electronic apparatus includes an authority information acquisition unit that acquires a user's authority information; a first storage unit that stores current control information currently used to control the apparatus; a second storage unit that stores current configuration information representing a current configuration of the apparatus; an available control information outputting unit that outputs available control information allowed to be acquired; an instruction accepting unit that accepts an instruction to acquire at least one of versions of available control information output by the available control information outputting unit; an information acquisition unit that acquires control information according to the instruction accepted by the instruction accepting unit; and an updating unit that updates the current control information stored in the first storage unit.

### CROSS-REFERENCE TO RELATED APPLICATIONS

This application is based on and claims priority under 35 USC 119 from Japanese Patent Application No. 2009-074704 filed Mar. 25, 2009.

### BACKGROUND

### Technical Field

The present invention relates an electronic apparatus and an image forming system.

### SUMMARY

According to an aspect of the invention, there is provided an electronic apparatus including an authority information acquisition unit that acquires a user's authority information; a first storage unit that stores current control information currently used to control the electronic apparatus; a second storage unit that stores current configuration information representing a current configuration of the electronic apparatus; an available control information outputting unit that outputs available control information allowed to be acquired depending on the current configuration information stored in the second storage unit and the authority information acquired by the authority information acquisition unit; an instruction accepting unit that accepts an instruction to acquire at least one of versions of available control information output by the available control information outputting unit; an information acquisition unit that acquires control information according to the instruction accepted by the instruction accepting unit; and an updating unit that updates the current control information stored in the first storage unit, based on the control information acquired by the information acquisition unit.

### BRIEF DESCRIPTION OF THE DRAWINGS

An exemplary embodiment of the present invention will be described in detail based on the following figures, wherein:

FIG. 1 is an architectural diagram showing an overview of an image forming system in accordance with an exemplary embodiment of the invention;

FIG. 2 is a conceptual diagram showing a structure of an image forming apparatus;

FIG. 3 is a conceptual diagram showing a structure of an updating program for updating control information and setup information stored on a storage device;

FIG. 4 is a table tabulating relevant information relating to authority information for operators and control information;

FIG. 5 is a flowchart illustrating a process (S10) that the image forming apparatus performs to acquire control information using the updating program;

FIG. 6 is a flowchart illustrating a process (S20) that the image forming apparatus performs to update control information using the updating program after completing the process (S10) to acquire control information illustrated in FIG. 5:

FIG. 7 shows an exemplary screen displayed on the UI equipment, while the image forming apparatus notifies the management server of configuration information, the maximum number of control information sets allowed to acquire (the number of queries allowed), etc.;

FIGS. 8A and 8B show exemplary screens displayed on the UI equipment corresponding to results of decision as to whether updating of control information is needed by the image forming apparatus depending on authority information, wherein FIG. 8A is an example of a screen to indicate that no updating is needed and FIG. 8B is an example of a screen prompting the operator to choose whether to execute updating of control information;

FIGS. 9A and 9B show exemplary screens displayed on the UI equipment, when plural versions of control information are available for updating depending on authority information, wherein FIG. 9A is an example of a screen to indicate that the operator can select and acquire one of the plural versions of control information and FIG. 9B is an example of a screen prompting the operator to choose whether to execute updating of one selected version of control information; and

FIGS. 10A and 10B show exemplary screens displayed on the UI equipment when the image forming apparatus acquires control information, wherein FIG. 10A is an example of a screen during the acquisition and FIG. 10B is an example of a screen after the acquisition.

### DETAILED DESCRIPTION

In the following, an exemplary embodiment of the present invention will be described, based on the drawings.

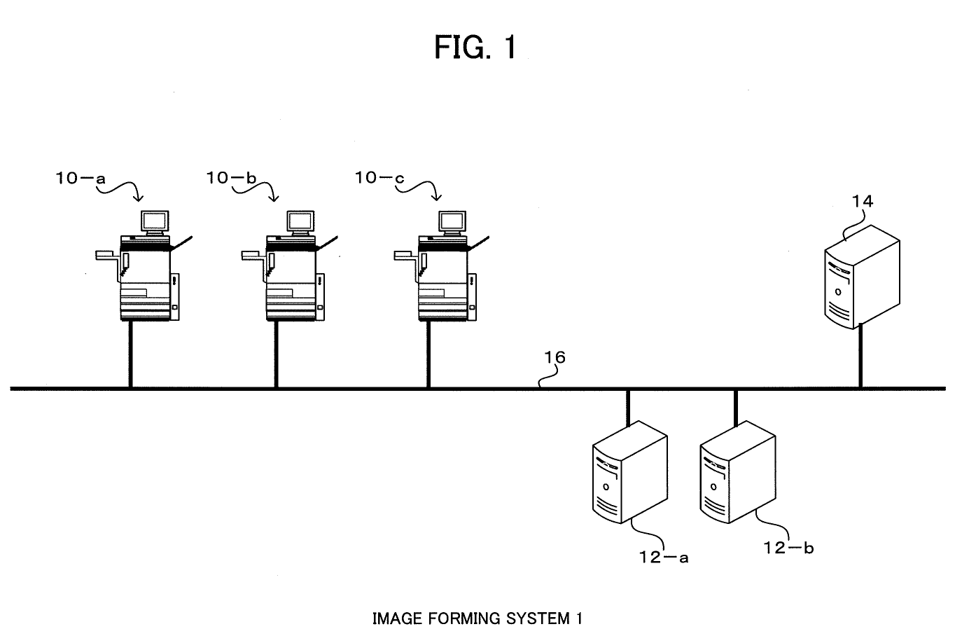

FIG. 1 illustrates an overview of an image forming system 1 according to an exemplary embodiment of the information. The image forming system 1 includes, for example, image forming apparatuses 10-1 to 10-c, information servers 12-a, 12-b, and a management server 14. The image forming apparatuses 10-1 to 10-c, the information servers 12-a, 12-b, and the management server 14 are interconnected via a network 16, e.g., Internet.

The image forming apparatuses 10-1 to 10-c are complex machines with various functions, e.g., printing, copying, facsimile transmission and reception, and scanning, but their detailed structures differ from each other. For example, the image forming apparatuses 10-1 to 10-c differ in terms of control information such as machine type and firmware, versions of individual setup information and the like associated with the control information, peripheral device configurations, and settings to enable the functions.

The information servers 12-a, 12b have functionality as a computer and they serve as software repositories storing control information such as plural versions of firmware and the like to be used in the image forming apparatuses 10-1 to 10-c, and setup information associated with the control information.

The management server 14 stores storage destinations of control information and setup information that is to be used depending on the machine type, peripheral device configuration, etc. of the image forming apparatuses 10-1 to 10-c, etc. That is, the management server 14 provides information about locations in the information servers 12-a, 12-b where the control information and setup information appropriate for each of the image forming apparatuses 10-1 to 10-c, etc. are stored. The management server 14 sends such information in response to a request from the image forming apparatuses 10-1 to 10-c.

In the following, the image forming apparatuses 10-1 to 10-c, etc. may be simply referred to as an “image forming apparatus 10”, where there is no need to identify any of the plural entities.

Then, an image forming apparatus 10 is described in detail.

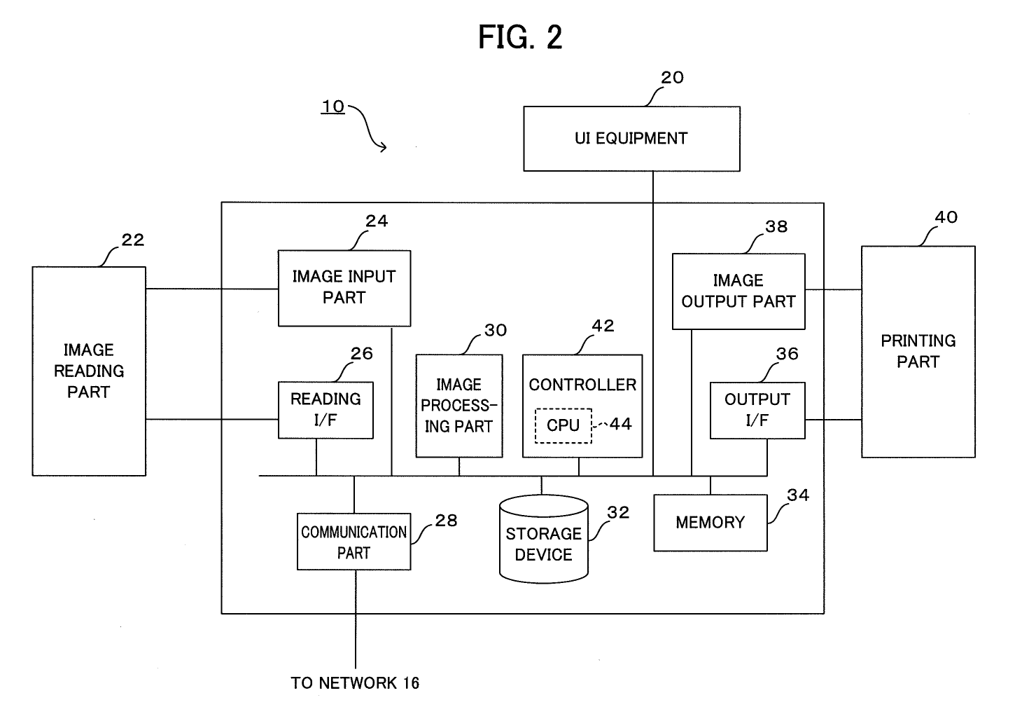

FIG. 2 is a conceptual diagram showing a structure of the image forming apparatus 10.

The image forming apparatus 10 includes, e.g., user interface (UI) equipment 20, an image reading part 22, an image input part 24, a reading interface (IF) 26, a communication part 28, an image processing part 30, a storage device 32, a memory 34, an output interface (I/F) 36, an image output part 38, a printing part 40, and a controller 42.

The UI equipment 20 is formed of, e.g., a touch panel and it receives input of an instruction and the like from an operator (user) and provides a display to the operator. The image reading part 22 is formed of, e.g., a scanner and it reads an image such as a document and outputs the image to the image input part 24. The image input part 24 is connected to the image reading part 22, subserved by the reading I/F 26, and it receives image data which has been read by the image reading part 22 as an input image and outputs the input image to, e.g., the storage device 32. The communication part 28 connects the image forming apparatus 10 to the information servers 12-a, 12-b and the management server 14 via the network 16. The image processing part 30 performs image processing including image compression, decompression, combining etc. The storage device 32 stores the above-mentioned control information and setup information as well as configuration information representing the configuration of the image forming apparatus 10. Information stored in the storage device 32 can be updated by control of the controller 42. The image output part 38 renders an image yielded by processing of the image processing part 30 and others into an output image which is in turn output to the printing part 40, subserved by the output I/F 36. The printing part 40 is an electrophotographic image forming part including an image carrier (not shown) made of, e.g., a photoreceptor and other components and it forms an image on a recording medium such as paper.

The controller 42 includes a CPU 44 and controls the components of the image forming apparatus 10. Thus, the image forming apparatus 10 has a function as a computer and forms an image on a recording medium by executing prearranged programs.

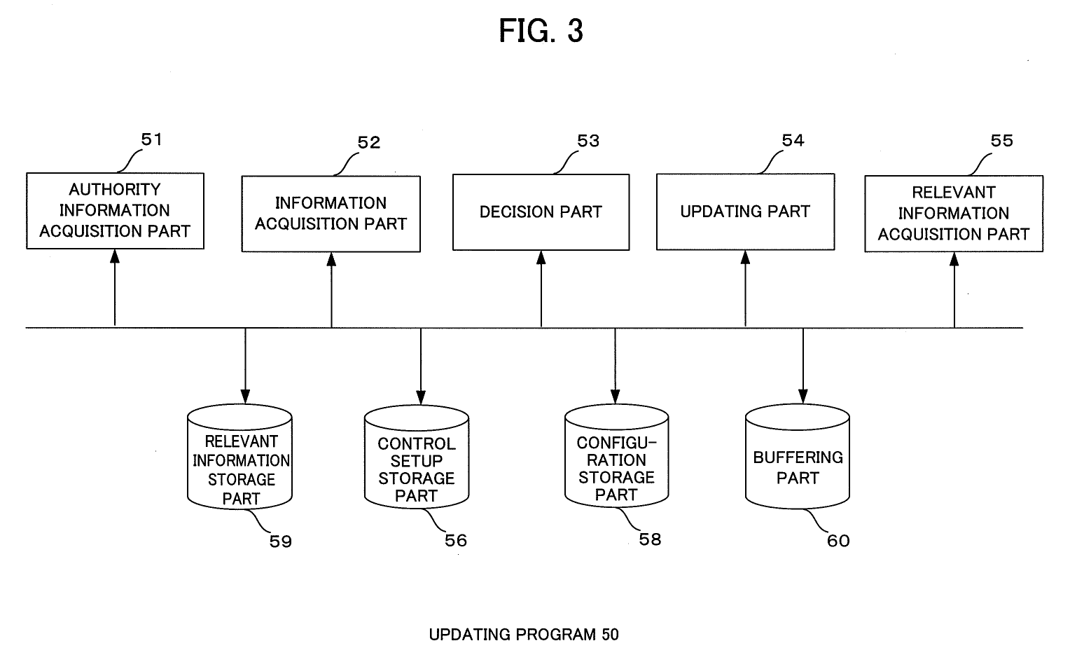

FIG. 3 is a conceptual diagram showing a structure of an updating program for updating control information and setup information stored on the storage device 32.

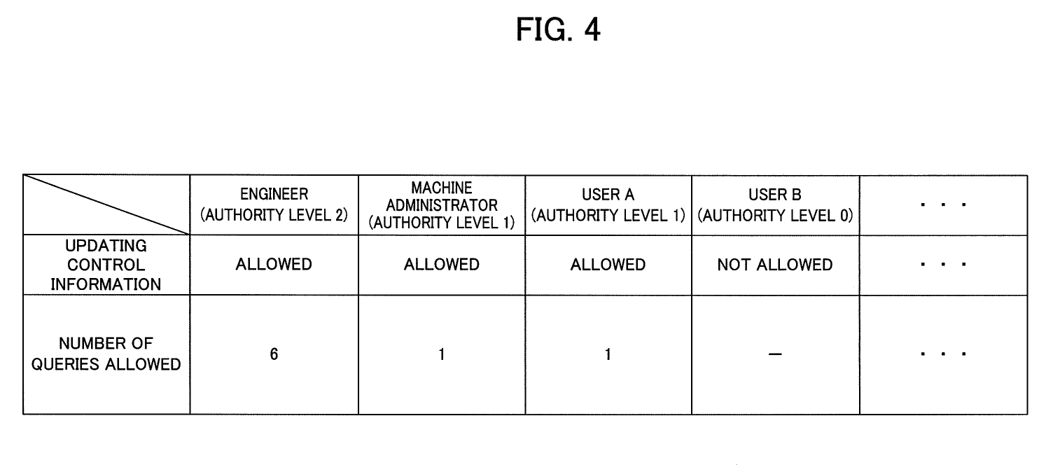

FIG. 4 is a table tabulating relevant information relating to authority information for operators and control information.

As is shown in FIG. 3, the updating program 50 includes an authority information acquisition part 51, an information acquisition part 52, a decision part 52, updating part 54, a relevant information acquisition part 55, a control setup storage part 56, a configuration storage part 58, a relevant information storage part 59, and a buffering part 60.

The relevant information acquisition part 55 fetches relevant information (FIG. 4) stored in the relevant information storage part 59 and outputs that information to the authority information acquisition part 51. With regard to relevant information stored in the relevant information storage part 59, authority levels predetermined for each operator are set. The authority levels are, for example, values from 0 to 2 to which different levels of authority information are mapped. The authority levels are arranged so that, as the authority level value of an operator is larger, the operator is allowed to make available more versions of control information and setup information. For example, an engineer who is assigned an authority level of 2 is allowed to update control information and a maximum number of information versions available (the number of queries allowed) is set to 6. Further, a machine administrator who is assigned an authority level of 1 is allowed to update control information and the maximum number of information versions available (the number of queries allowed) is set to 1. Further, a user A who is assigned an authority level of 1 is allowed to update control information and the maximum number of information versions available (the number of queries allowed) is set to 1. In this exemplary setting, a user B who is assigned an authority level of 0 is not allowed to update control information. If an operator whose authority level is 0 or an operator to whom no authority level is granted performs an input operation for update by operating the UI equipment 20, the UI equipment 20 displays a message that you may not update control information. The UI equipment 20 may be adapted to provide no display relevant to updating control information, when operated by such an operator whose authority level is 0 or an operator to whom no authority level is granted.

Setup information may be sent and received as a part of control information. In the following, it is assumed that control information may include setup information when it is sent and received or in a similar situation.

The control setup storage part 56 (FIG. 3) stores current control information and current setup information for the image forming apparatus 10.

The configuration storage part 58 stores current configuration information for the image forming apparatus 10. The current configuration information for the image forming apparatus 10 includes information specifying detailed configuration of the image forming apparatus 10 and information specifying detailed configuration of peripheral devices (e.g., the image reading part 22 such as a scanner) connected to the image forming apparatus 10.

The authority information acquisition part 51 identifies (and authenticates) an operator, for example, according to the operator ID and password entered via the UI equipment 20, receives relevant information which is output by the relevant information acquisition part 55, and acquires authority information indicating what authority is associated with the operator among the authority levels fixed on a per-operator basis.

When an operator issues a request to acquire at least one of control information and setup information to be updated by the image forming apparatus 10 via the UI equipment 20, the information acquisition part 52 sends the management server 14 via the communication part 28 the following information: authority information acquired by the authority information acquisition part 51, information identifying what control information and what setup information stored in the control setup storage part 56, and configuration information stored in the configuration storage part 58. Depending on information received from the management server 14, the information acquisition part 52 acquires control information and setup information from the information servers 12-a, 12-b and output them to, e.g., the buffering part 60.

The decision part 53 decides whether a peripheral device connected to the image forming apparatus 10 is a predefined one (e.g., it conforms to a predefined type). If the peripheral device connected to the image forming apparatus 10 is not the predefined one, the decision part 53 outputs a signal causing the controller 42 to inhibit updating of control information and a signal causing the UI equipment 20 to provide a display to indicate that updating of control information is inhibited.

Once the information acquisition part 52 has acquired control information and setup information from the information servers 12-a, 12-b, the updating part 54 updates the control information and configuration information stored in the control setup storage part 56, according to the control information and the setup information stored in, e.g., the buffering part 60 and the configuration information stored in the configuration storage part 58.

For example, when the image forming apparatus 10 is rebooted, it is determined whether new control information and new setup information have been acquired. If so, the updating program 50 is adapted to serve as a boot program that triggers updating according to the acquired information, without operating in the normal operation mode upon the rebooting. Thereby, operation in the normal operation mode is initiated by rebooting after the updating.

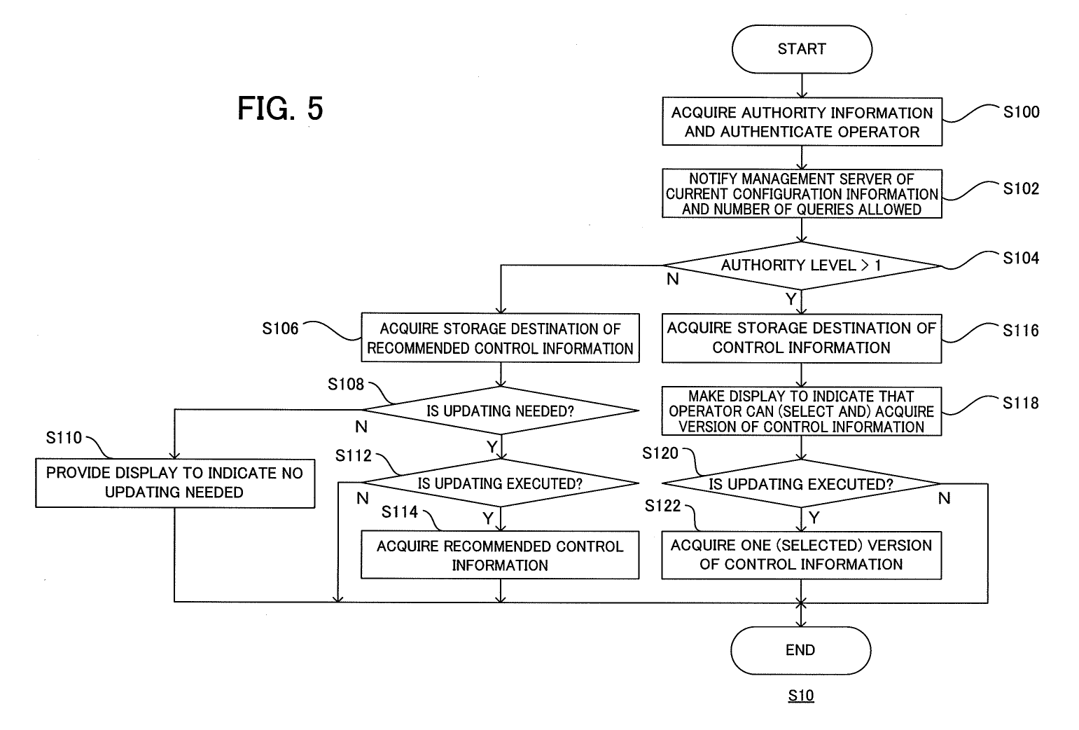

FIG. 5 is a flowchart illustrating a process (S10) that the image forming apparatus 10 performs to acquire control information using the updating program 50.

As can be seen in FIG. 5, at step 100 (S100), the image forming apparatus 10 acquires the operator's authority information (authenticates the operator), according to information entered via the UI equipment 20.

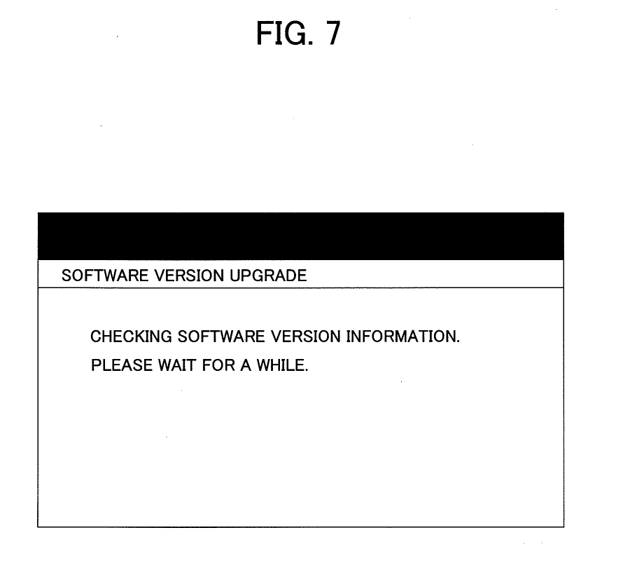

At step 102 (S102), the image forming apparatus 10 notifies the management server 14 of current configuration information stored in the configuration storage part 58, the maximum number of control information versions available (the number of queries allowed), etc. At this time, the UI equipment 20 displays a screen, for example, as illustrated in FIG. 7.

At step 104 (S104), the image forming apparatus 10 determines whether the operator's authority level is higher than 1. If the level is higher than 1, the process goes to step S116; if the level is 1, the process goes to step S106.

At step 106 (S106), the image forming apparatus 10 tries to acquire a storage destination of recommended control information from the management server 14.

At step 108 (S108), the image forming apparatus 10 determines whether there is no storage destination acquired in step S106 (whether the storage destination is successfully acquired). If there is no storage destination acquired, the image forming apparatus 10 determines that no updating is needed and proceeds to step S110. If not (i.e., the storage destination has been acquired), the image forming apparatus 10 determines that updating is needed and proceeds to step S112.

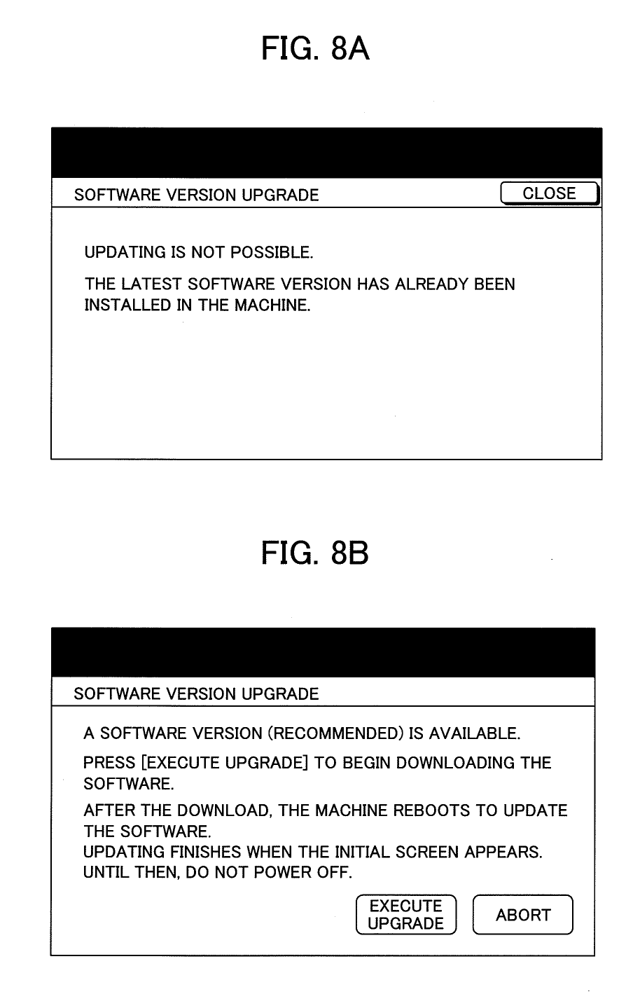

At step 110 (S110), the UI equipment 20 provides a display to indicate that no updating of control information is needed. For example, the UI equipment 20 displays a screen as illustrated in FIG. 8A.

At step 112 (S112), the image forming apparatus 10 determines whether to execute updating of control information depending on the operator's choice entered via the UI equipment 20. If the apparatus has determined to execute updating, the process goes to step S114; if not, the process terminates. For example, in response to a screen as illustrated in FIG. 8B, the operator can choose whether to execute updating of control information via the UI equipment 20.

At step 114 (S114), the image forming apparatus 10 accesses one of the information servers 12-a, 12-b which is the storage destination acquired from the management server 14 and acquires the control information.

At step 116 (S116), the image forming apparatus 10 acquires a storage destination of control information depending on the authority information.

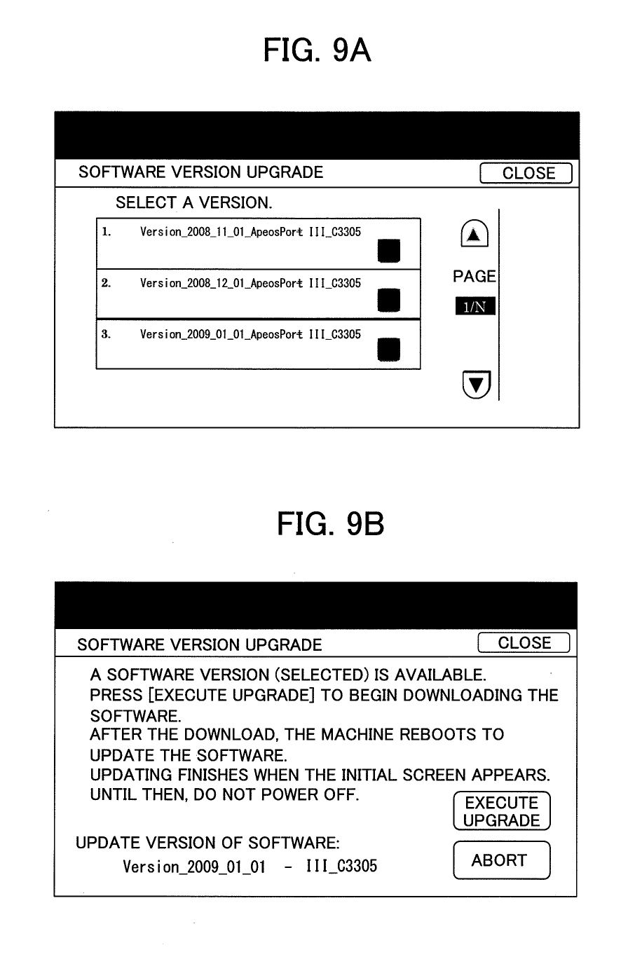

At step 118 (S118), the image forming apparatus 10 makes a display via the UI equipment 20 to indicate that the operator can (select) and acquire control information. For example, the UI equipment 20 displays a screen as illustrated in FIG. 9A, which indicates that plural versions of control information are available, allowed by the authority information, and that you can select any of the versions of control information.

At step 120 (S120), the image forming apparatus 10 determines whether to execute updating of control information depending on the operator's choice entered via the UI equipment 20. If the apparatus has determined to execute updating, the process goes to step S122; if not, the process terminates. For example, in response to a screen as illustrated in FIG. 9B, the operator can choose whether to execute one selected version of control information via the UI equipment 20.

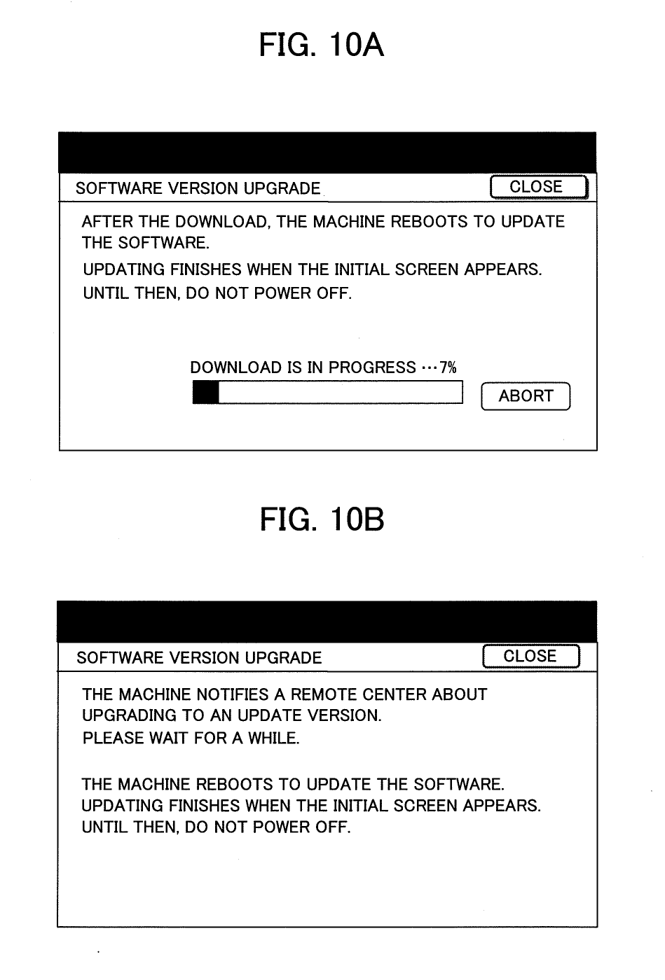

At step 122 (S122), the image forming apparatus 10 acquires the one (selected) version of control information by accessing one of the information servers 12-a, 12-b which is the storage destination acquired from the management server 14. For example, the UI equipment 20 displays a screen as illustrated in FIG. 10A during the acquisition of the control information and displays a screen as illustrated in FIG. 10B after the acquisition of the control information.

In the process of S10, for example, it is assumed to send and receive control information including setup information.

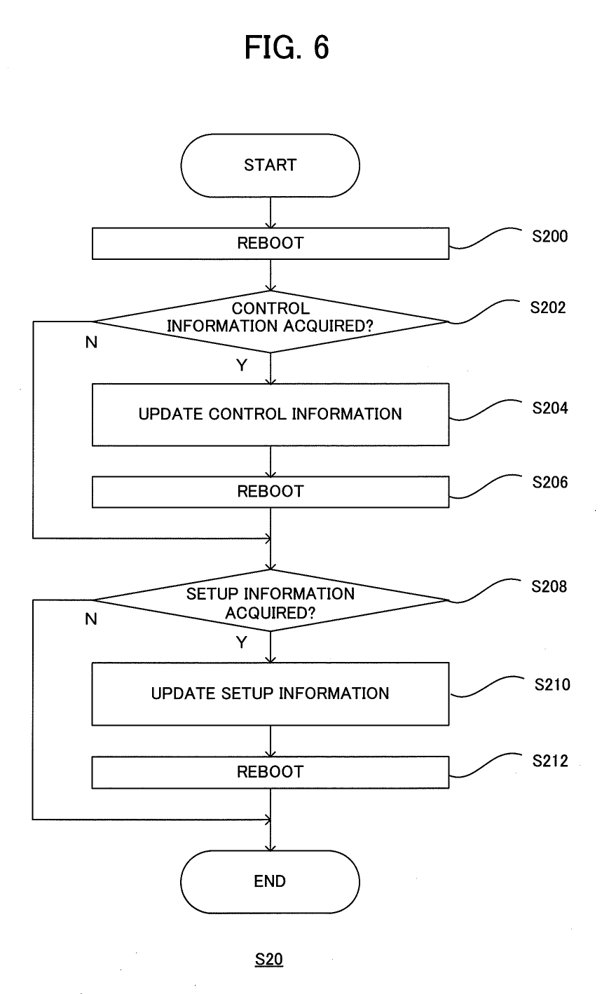

FIG. 6 is a flowchart illustrating a process (S20) that the image forming apparatus 10 performs to update at least one of control information (and setup information) using the updating program after completing the process (S10) to acquire control information illustrated in FIG. 5.

As can be seen in FIG. 6, at step 200 (S200), the image forming apparatus 10 reboots, triggered by the operator via the UI equipment 20. For example, the screen as illustrated in FIG. 10B displayed on the UI equipment 20 prompts the user to reboot the image forming apparatus 10.

At step 202 (S202), the image forming apparatus 10 determines whether control information has been acquired. If new control information has been acquired, the process goes to step S204; if not, the process goes to step S208.

At step 204 (S204), the image forming apparatus 10 updates the control information depending on the operator's choice entered via the UI equipment 20.

At step 206 (S206), the image forming apparatus 10 reboots.

At step 208 (S208), the image forming apparatus 10 determines whether setup information has been acquired. If new setup information has been acquired, the process goes to step S210; if not, the process terminates.

At step 210 (S210), the image forming apparatus 10 updates the setup information.

At step 212 (S212), the image forming apparatus 10 reboots. After the step S212, the image forming apparatus 10 starts to operate in the normal operation mode, as there remains neither control information nor setup information to be updated.

The present invention may be embodied in other specific forms without departing from its spirit or characteristics. The described exemplary embodiment is to be considered in all respects only as illustrated and not restrictive. The scope of the invention is, therefore, indicated by the appended claims rather than by the foregoing description. All changes which come within the meaning and range of equivalency of the claims are to be embraced within their scope.

What is claimed is:

1. An electronic apparatus comprising:
an authority information acquisition unit that acquires a user's authority information;
a first storage unit that stores current control information currently used to control the electronic apparatus;
a second storage unit that stores current configuration information representing a current configuration of the electronic apparatus;
an available control information outputting unit that outputs available control information allowed to be acquired depending on the current configuration information stored in the second storage unit and the authority information acquired by the authority information acquisition unit;
an instruction accepting unit that accepts an instruction to acquire at least one of versions of available control information output by the available control information outputting unit;
an information acquisition unit that acquires control information according to the instruction accepted by the instruction accepting unit; and
an updating unit that updates the current control information stored in the first storage unit, based on the control information acquired by the information acquisition unit.

2. The electronic apparatus according to claim 1, further comprising a relevant information acquisition unit that fetches relevant information relating to the user's authority information and the available control information output by the available control information outputting unit,
wherein the available control information outputting unit outputs the available control information allowed to be acquired, based on the relevant information fetched by the relevant information acquisition unit and the authority information acquired by the authority information acquisition unit.

3. The electronic apparatus according to claim 1, comprising a main body of the electronic apparatus and a peripheral device connected to the main body of the electronic apparatus,
wherein the main body of the electronic apparatus further includes:
a decision unit that decides whether the peripheral device is a predefined one; and
a controller that controls the instruction accepting unit to inhibit accepting an instruction, if the decision unit has decided that the peripheral device is not the predefined one.

4. The electronic apparatus according to claim 3, further comprising an inhibition information outputting unit that outputs information indicating that the instruction accepting unit inhibits accepting an instruction in a case where the controller controls the instruction accepting unit to inhibit accepting an instruction.

5. The electronic apparatus according to claim 2, further comprising:
a controller that controls the instruction accepting unit to inhibit accepting an instruction, if the authority information acquired by the authority information acquisition unit does not conform to the relevant information acquired by the relevant information acquisition unit; and
an inhibition information outputting unit that outputs information indicating that the instruction accepting unit inhibits accepting an instruction in a case where the controller controls the instruction accepting unit to inhibit accepting an instruction.

6. The electronic apparatus according to 2, further comprising an output controller that controls the available control information outputting unit not to output available control information, if the authority information acquired by the authority information acquisition unit does not conform to the relevant information acquired by the relevant information acquisition unit.

7. The electronic apparatus according to claim 1, wherein the instruction accepting unit is adapted to allow accepting an instruction to select and acquire one of versions of control information satisfying predefined conditions.

8. The electronic apparatus according to claim 1, further comprising an image forming unit that forms an image on a recording medium.

9. An image forming system comprising:
one or more image forming apparatuses;
a first storage unit that stores control information for controlling each of the image forming apparatuses depending on their configuration; and
a permitting unit that permits acquisition of control information stored on the first storage unit, based on authority information for a user who uses each of the image forming apparatuses,
each of the image forming apparatuses including:
an authority information acquisition unit that acquires authority information for a user who uses the image forming apparatus;
a second storage unit that stores current control information currently used to control the image forming apparatus;
a third storage unit that stores current configuration information representing a current configuration of the image forming apparatus;
an available control information outputting unit that outputs available control information permitted by the permitting unit, based on the current configuration information stored in the third storage unit and the authority information acquired by the authority information acquisition unit;
an instruction accepting unit that accepts an instruction to acquire at least one of versions of available control information output by the available control information outputting unit from the first storage unit;
an information acquisition unit that acquires control information according to the instruction accepted by the instruction accepting unit from the first storage unit; and
an updating unit that updates the current control information stored in the second storage unit, based on the control information acquired by the information acquisition unit.
